(19) United States
(12) Patent Application Publication
(10) Pub. No.: US 2025/0247368 A1
(43) Pub. Date: Jul. 31, 2025

(54) EFFICIENT GENERATION OF DIFFERENTIAL PRIVACY NOISE

(71) Applicant: Google LLC, Mountain View, CA (US)

(72) Inventors: Phi Hung Le, New York, NY (US); Craig William Wright, Louisville, CO (US); Pasin Manurangsi, Bangkok (TH); Jiayu Peng, Sunnyvale, CA (US); Mariana Raykova, New York, NY (US); Baiyu Li, San Mateo, CA (US); Benjamin Kreuter, Jersey City, NJ (US)

(21) Appl. No.: 19/039,526

(22) Filed: Jan. 28, 2025

Related U.S. Application Data
(60) Provisional application No. 63/626,418, filed on Jan. 29, 2024.

(51) Int. Cl. H04L 9/40

(52) U.S. Cl. CPC H04L 63/04

(57) ABSTRACT

Methods, systems, and apparatus, including computer programs encoded on a computer storage medium, for generating differential privacy noise and applying the noise to data. In one aspect, a method includes obtaining a first binomial distribution parameter. Target differential privacy parameters representing a target level of differential privacy are obtained. The target differential privacy parameters include a first target differential privacy parameter representing a privacy metric that controls a level of privacy of data. For each value of multiple values of a second binomial distribution parameter, an actual value of a first actual differential privacy parameter that represents an actual privacy metric is determined based on the value of the second binomial distribution parameter. A determination is made whether the actual value of the first differential privacy parameter satisfies the first target differential privacy parameter. A selection is made of a given value of the second binomial distribution parameter.

### CROSS-REFERENCE TO RELATED APPLICATIONS

This application claims the benefit under 35 U.S.C. § 119(e) of priority to U.S. Provisional Application No. 63/626,418, titled “EFFICIENT SECURE MULTIPARTY COMPUTATION PROTOCOL FOR GENERATING NOISE,” filed on Jan. 29, 2024, which is hereby incorporated by reference in its entirety and for all purposes.

### TECHNICAL FIELD

This specification generally relates to data security, data privacy, and differential privacy.

### BACKGROUND

Differential privacy is a framework for protecting the privacy of individuals when their data is included in datasets. For example, differential privacy can prove limits on how much information an outputted result that is based on the dataset may reveal about an individual item in the dataset. Differential privacy can be used to generate aggregate reports and/or statistical information while preserving the privacy of users for which data is included in the reports and/or statistical information. In general, noise can be added to data such that data provided in response to a query is differentially private. However, there is a tradeoff between the amount of noise added and the accuracy and utility of the data provided in response to the queries.

### SUMMARY

This specification describes methods, computer systems, and apparatus, including computer programs encoded on computer storage media, for generating noise for differential privacy.

In general, one innovative aspect of the subject matter described in this specification can be embodied in methods that include the actions of obtaining a first binomial distribution parameter; obtaining target differential privacy parameters representing a target level of differential privacy, the target differential privacy parameters comprising a first target differential privacy parameter representing a privacy metric that controls a level of privacy of data; for each value of multiple values of a second binomial distribution parameter, determining, based on the value of the second binomial distribution parameter, an actual value of a first actual differential privacy parameter that represents an actual privacy metric, and determining whether the actual value of the first differential privacy parameter satisfies the first target differential privacy parameter; selecting, from a set of values of the second binomial distribution parameters for which the actual value of the first actual differential privacy parameter satisfies the first target differential privacy parameter, a given value of the second binomial distribution parameter; generating differential privacy noise using the first binomial distribution parameter and the given value of the second binomial distribution parameter; and applying the differential privacy noise to data to generate noised data. Other implementations of this aspect include corresponding apparatus, systems, and computer programs, configured to perform the aspects of the methods, encoded on computer storage devices.

These and other embodiments can each optionally include one or more of the following features. Some aspects include sending the noised data to one or more recipients after applying the differential privacy noise to the data.

In some aspects, the data include data for digital components. The data for the digital components can include network data measurement data for the digital components.

In some aspects, the first binomial distribution parameter includes a number (n) of experiments parameter and the second binomial distribution parameter comprises a probability (p) parameter.

In some aspects, obtaining the distribution parameters includes obtaining the distribution parameters based on an almost concentrated differential privacy (ACDP) approach.

In some aspects, determining whether the actual value of the first differential privacy parameter satisfies the first target differential privacy parameter includes determining multiple values of a Renyi divergence order until a stop condition is reached.

In some aspects, determining an actual value of a first actual differential privacy parameter includes performing a binary search for the first actual differential privacy parameter.

In some aspects, for each of multiple values of the second binomial distribution parameter, determining, based on the value of the second binomial distribution parameter, the actual value of the first actual differential privacy parameter includes performing a first procedure to iterate through the multiple values of the second binomial distribution parameter and, for each iteration of the first procedure, calling a second procedure to determine the actual value of the first actual differential privacy parameter, wherein calling the second procedure comprises providing, as input to the second procedure, the value of the second binomial distribution parameter, a value of the first binomial distribution parameter, and a value of a second target differential privacy parameter that represents a probability of a privacy leakage. The second procedure can include determining a Renyi divergence between two truncated binomial distributions and updating the value of the first actual differential privacy parameter based on the Renyi divergence.

Particular embodiments of the subject matter described in this specification can be implemented so as to realize one or more of the following advantages. The techniques for generating differential privacy noise described in this document results in a lower error rate and is more computationally efficient as compared to other differential privacy techniques (e.g., conventional Gaussian techniques). For example, using an Almost Concentrated Differential Privacy (ACDP) definition of differential privacy and the corresponding techniques for generating binomial parameters for use in generating differential privacy noise provides more flexibility (e.g., in the sense that it allows each query to consume different amounts of privacy budget), requires less computational resources (e.g., fewer computations, fewer process cycles, less consumed memory, fewer memory operations, etc.), and results in more accurate data output in response to queries. The resultant noised data also results in less use of a privacy budget for each query or a combination of queries. This enables more queries on a dataset without leaking an individual's data and/or enhanced privacy for the same number of queries. Thus, the data can be used more effectively by consumers of the data without risking data leaks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a network measurement system generates differentially private data.

FIG. 2 is a flow diagram of an example process for generating differential privacy noise.

FIG. 3 is a flow diagram of an example process for applying differential privacy noise to data of a dataset and providing the noised data to a recipient.

FIG. 4 is a graph that illustrates the error standard deviations of differential privacy definitions.

FIG. 5 is a block diagram of an example computer system.

Like reference numbers and designations in the various drawings indicate like elements.

### DETAILED DESCRIPTION

In general, this specification describes systems and techniques for generating binomial distribution parameters of a binomial distribution and using the binomial distribution parameters to generate differential privacy noise. The generated noise can be added to data of a dataset, e.g., to aggregated data or statistical information generated using the data of the dataset. The generated noise can satisfy any (ϵ, δ) differential privacy approach or level within the approach.

In general, the techniques for generating the differential privacy noise include determining a binomial distribution (Binomial(n, p)) that satisfies the target level of differential privacy. This includes identifying the distribution parameters, which include a number (n) of experiments parameter and a probability (p) parameter for the binomial distribution. The probability parameter can indicate the probability of each experiment being a success. To add noise to the data, a value can be obtained, e.g., selected, from the binomial distribution and added to the data.

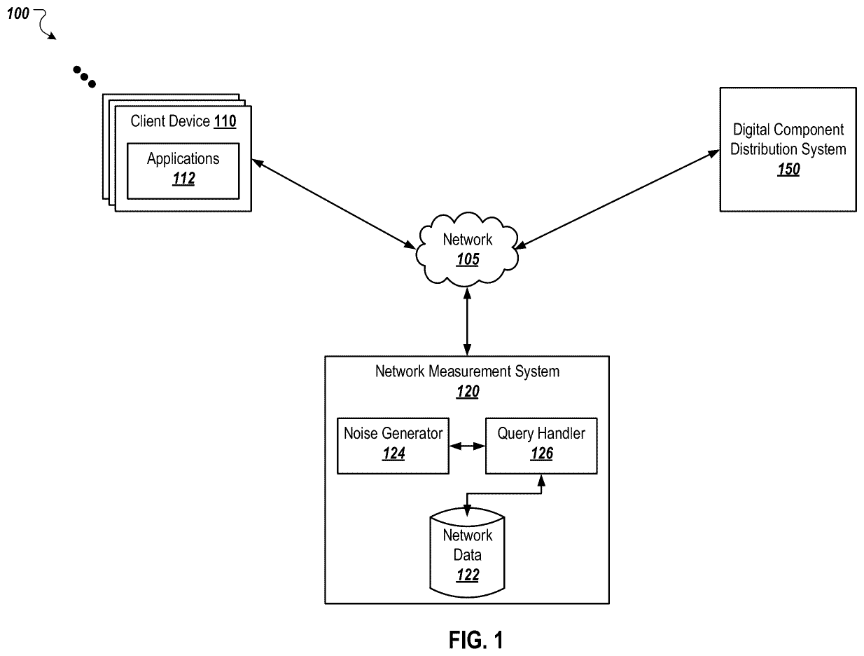

FIG. 1 is a block diagram of an example environment 100 in which a network measurement system 120 generates differentially private data. The environment 100 includes a data communication network 105, such as a local area network (LAN), a wide area network (WAN), the Internet, a mobile network, or a combination thereof. The data communication network 105 connects client devices 110 with a network measurement system 120 and a digital component distribution system 150.

As described in more detail below, the network measurement system 120 generates differential privacy noise that can be applied to data of a dataset. The noise can be applied to any type of data. One example type of data is network measurement data related to the distribution of digital components across the network 105. This network measurement data can include, for example, the number of presentations of digital components, the number of unique users to which a digital component has been presented, the number of user interactions with the digital components, the number of conversion events resulting from presentations of the digital components, subsets of these counts for various time periods, locations, etc., and/or other data related to digital components.

As used throughout this specification, the “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component. For example, the digital component may be content that is intended to supplement the content of a web page or other resource presented by the application 112. More specifically, the digital component may include digital content that is relevant to the resource content (e.g., the digital component may relate to the same topic as the web page content, or to a related topic). The provision of digital components can thus supplement, and generally enhance, the web page or application content.

Further to the descriptions throughout this document, a user may be provided with controls (e.g., user interface elements with which a user can interact) allowing the user to make an election as to both if and when systems, programs, or features described herein may enable the collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no apparently personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A client device 110 is an electronic device capable of requesting and receiving online resources over the network 105. Example client devices 110 include personal computers, gaming devices, mobile communication devices, digital assistant devices, augmented reality devices, virtual reality devices, and other devices that can send and receive data over the network 105. A client device 110 can also include a digital media device, e.g., a streaming device that plugs into a television or other display to stream videos to the television.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

The client device 110 can include applications 112, such as web browsers and/or native applications, to facilitate the sending and receiving of data over the network 105. A native application is an application developed for a particular platform or a particular device (e.g., mobile devices having a particular operating system). Although operations may be described as being performed by the client device 110, such operations may be performed by an application 112 running on the client device 110.

The applications 112 can present electronic resources, e.g., web pages, application pages, other application content, or electronic documents, to a user of the client device 110. The electronic resources can include digital component slots for presenting digital components with the content of the electronic resources. A digital component slot is an area of an electronic resource (e.g., web page or application page) for displaying a digital component. A digital component slot can also refer to a portion of an audio and/or video stream (which is another example of an electronic resource) for playing a digital component.

When the application 112 loads a resource that includes a digital component slot, the application 112 can generate a digital component request that requests a digital component for display in the digital component slot. In some implementations, the digital component slot and/or the resource can include code (e.g., scripts) that cause the application 112 to request a digital component from the digital component distribution system 150.

The client device 110 can present an electronic document, which is a type of electronic resource. An electronic document is data that presents a set of content at a client device 110. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices can also be referred to as electronic resources or electronic documents. Electronic documents can be provided to client devices 110 by electronic document servers.

For example, the electronic document servers can include servers that host publisher websites. In this example, the client device 110 can initiate a request for a given publisher webpage, and the electronic server that hosts the given publisher webpage can respond to the request by sending machine executable instructions that initiate presentation of the given webpage at the client device 110.

In another example, the electronic document servers can include app servers from which client devices 110 can download apps. In this example, the client device 110 can download files required to install an app at the client device 110, and then execute the downloaded app locally (i.e., on the client device). Alternatively, or additionally, the client device 110 can initiate a request to execute the app, which is transmitted to a cloud server. In response to receiving the request, the cloud server can execute the application and stream a user interface of the application to the client device 110 so that the client device 110 does not have to execute the app itself. Rather, the client device 110 can present the user interface generated by the cloud server's execution of the app and communicate any user interactions with the user interface back to the cloud server for processing.

Electronic documents can include a variety of content. For example, an electronic document can include native content that is within the electronic document itself and/or does not change over time. Electronic documents can also include dynamic content that may change over time or on a per-request basis. For example, a publisher of a given electronic document can maintain a data source that is used to populate portions of the electronic document. In this example, the given electronic document can include a script that causes the client device 110 to request content (e.g., a digital component) from the data source when the given electronic document is processed (e.g., rendered or executed) by a client device 110 (or a cloud server). The client device 110 (or cloud server) integrates the content (e.g., digital component) obtained from the data source into the given electronic document to create a composite electronic document including the content obtained from the data source.

In some situations, a given electronic document can include a digital component script that references the digital component distribution system 150, or a particular service provided by the digital component distribution system 150. In these situations, the digital component script is executed by the client device 110 when the given electronic document is processed by the client device 110. Execution of the digital component script configures the client device 110 to generate a request for digital components (referred to as a “component request”), which is transmitted over the network 105 to the digital component distribution system 150. For example, the digital component script can enable the client device 110 to generate a packetized data request including a header and payload data. The component request is transmitted, by the client device 110, over the network 105 to a server of the digital component distribution system 150.

The digital component distribution system 150 selects digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script) in response to receiving the component request and/or using information included in the component request.

In some implementations, a digital component is selected in less than a second to avoid errors that could be caused by delayed selection of the digital component. For example, delays in providing digital components in response to a component request can result in page load errors at the client device 110 or cause portions of the electronic document to remain unpopulated even after other portions of the electronic document are presented at the client device 110.

Also, as the delay in providing the digital component to the client device 110 increases, it is more likely that the electronic document will no longer be presented at the client device 110 when the digital component is delivered to the client device 110, thereby negatively impacting a user's experience with the electronic document. Further, delays in providing the digital component can result in a failed delivery of the digital component, for example, if the electronic document is no longer presented at the client device 110 when the digital component is provided.

The client device 110 can report events related to the presentation of digital components to the network measurement system 120. For example, digital components can include data, e.g., scripts, that instruct the client device 110 to send event data to the network measurement system 120. The event data can include, for example, data identifying a digital component presented by the client device 110, whether the user interacted with, e.g., selected, the digital component, the resource (e.g., electronic document) with which the digital component was presented, whether a conversion occurred after the user viewed or interacted with the digital component, and/or other information related to the presentation and/or user interaction with a digital component.

In some implementations, the digital component distribution system 150 can report event data for digital components to the network measurement system 120. For example, this event data can include the same event data as the client device 110 and/or other event data, e.g., conversion data that indicates whether a user of a client device 110 performed a specified action after viewing or interacting with a digital component. The specified action can include, for example, registering for a newsletter, signing up for an event, purchasing an item (e.g., product or service), adding an item to a virtual shopping cart, downloading an application (e.g., a mobile app), etc.

The network measurement system 120, which can be implemented as one or more computers in one or more locations, can store the event data in a network data storage device 122. The network data storage device 122 can include a data structure, e.g., a database, that stores the event data received from multiple client devices 110.

The network measurement system 120 can use the event data to generate network measurement data for the digital components. As described above, the network measurement data can include data related to presentations, user interactions, and/or other events related to digital components. The network measurement data can include presentation counts for digital components (e.g., the number of times a digital component has been presented), the number of unique users to which each digital component has been presented, the number of user interactions with each digital component, the rate at which users interact with each digital component, the number of times a specific action occurs after a digital component is presented or receives a user interaction (e.g., conversion rate), and/or a rate at which the specified action occurs following presentations of and/or user interactions with a digital component. To protect the security of such data and to preserve the privacy of user data used to generate such measurements, the network measurement system can generate noise that can be applied to the event data and/or network measurement data prior to the network measurement data being sent to a recipient. In this way, when the data is provided to recipients, the recipients cannot identify events or data related to particular users or learn other information about the particular users.

Although the examples described in this document relate to digital components, the differential privacy techniques described herein can be used to generate differentially private data for any other use case. For example, the techniques can be used to add differential privacy noise to demographic information, medical information, statistical information for a dataset, and/or other types of sensitive data of people or other types of datasets for other types of items.

The network measurement system 120 includes a noise generator 124 and a query handler 126, both of which can be implemented using one or more computers in one or more locations. The query handler 126 receives queries for network data, e.g., network measurement data based on the network data, and provides data that satisfies the queries to recipients. For example, the digital component distribution system 150 can send queries for network measurement data for digital components or groups of digital components (e.g., digital components for a same subject). Each query can specify criteria for the data, e.g., the type of measurement and the digital component(s) for which measurement data is requested. For example, a query can request the number of unique viewers to which a particular digital component was presented. The query can indicate the digital component or group of digital components using an identifier for the digital component or group of digital components.

The noise generator 124 is configured to generate differential privacy noise that the query handler 126 can add to the network measurement data before the network measurement data is sent to the recipient, e.g., to the digital component distribution system 150.

The distribution parameters can be determined based on a target level of differential privacy and/or a differential privacy approach, type, or definition. For example, the distribution parameters can be determined based on differential privacy parameters for a differential privacy approach. The distribution parameters for a binomial distribution can include a number (n) of experiments parameter and a probability (p) parameter. The probability parameter can indicate the probability of each experiment being a success.

In some implementations, the differential privacy approach is a (ϵ, δ) differential privacy ((ϵ, δ)-DP) approach. In this example, the differential privacy parameters include ϵ and δ. The parameter ϵ is a metric of privacy loss (which can control the level of privacy of a DP mechanism) and the parameter δ is a probability of privacy leakage.

Binomial distribution parameters can be determined for a (ϵ, δ)-DP approach using the differential privacy parameters ϵ and δ. For example, to sample the noise that meets (ϵ, δ)-DP, n binomial bits with bias ½b₁, . . . , bₙ can be sampled. In this example, the noise will be the sum of the bits: v=Σᵢ₌₁ⁿbᵢ. For the binomial noise with a bias of ½,

$$Pr [ v = \frac{n}{2} + x ] = ( \frac{n}{\frac{n}{2} + x} ) {( \frac{1}{2} )}^{n} = \frac{n !}{( \frac{n}{2} + x ) ! ( \frac{n}{2} - x ) !} {( \frac{1}{2} )}^{n} \\ Similarly , \\ Pr [ v = \frac{n}{2} + x + 1 ] = \frac{n !}{( \frac{n}{2} + x + 1 ) ! ( \frac{n}{2} - x - 1 ) !} {( \frac{1}{2} )}^{n}$$

Here, the relative probabilities are:

$$\frac{Pr [ v = \frac{n}{2} + x ]}{Pr [ v = \frac{n}{2} + x + 1 ]} = \frac{\frac{n}{2} + x + 1}{\frac{n}{2} - x}$$

According to “Our Data, Ourselves: Privacy via Distributed Noise Generation” by Cynthia Dwork et al., which is incorporated herein by reference, as long as x≤ϵn/8 and ϵ≤1, the relative probabilities should be no more than 1+ϵ<exp(ϵ). If n is selected such that

$$Pr [ v > \frac{n}{2} + ϵ n / 8 ] < \frac{δ}{2} ,$$

the noise v will meet (ϵ, δ)-DP. Using a Chernoff bound,

$$Pr [ v > \frac{n}{2} + ϵ n / 8 ] \leq exp ( - \frac{{ϵ}^{2} n}{64} ) .$$

The noise is (ϵ, δ) differential private as long as n is selected to be at least

$$\frac{64 log ( \frac{2}{δ} )}{{ϵ}^{2}} .$$

Another differential privacy (DP) approach for which distribution parameters can be determined is an Almost Concentrated Differential Privacy (ACDP) approach. Concentrated Differential Privacy (CDP) is another type/approach of differential privacy. One can translate CDP and (ϵ, δ) differential privacy parameters between each other. The CDP approach gives more flexible and efficient compositions for some types of noises such as Gaussian noises. The ACDP approach described herein is a modification of the CDP approach, which provides more flexibility and a more efficient composition for binomial noises than CDP.

For example, the ACDP approach can be more efficient with respect to composition. If the composition of a standard differential privacy approach and the composition with ACDP that is translated back to DP, then ACDP translated back to DP will outperform standard DP when the number of compositions is large. This means that using ACDP translated back to DP will lead to smaller noise per query than standard DP. That is, in ACDP translated back to standard DP, the dependency of the number of compositions in the privacy loss parameter ϵ is square root, whereas it is linear in standard DP.

In ACDP, a mechanism M is said to be (ρ, θ)-ACDP if, for every pair of neighboring datasets X⁰, X¹, there is another mechanism M′ such that d_{TV}(M(X), M′(X))≤θ for all X∈{X⁰, X¹} and D_{α}(M′(X)∥M′(X¹)≤α·ρ for all α>1. Here, for any two random distributions P and Q,
d_{TV}(P, Q) indicates the total variation distance between them, and

$${D}_{α} ( P ‖ Q ) := \frac{1}{α - 1} \cdot log {E}_{x \sim P} [ {( P ( x ) / Q ( x ) )}^{α - 1}$$

the α-Renyi Divergence.

A benefit of this definition is that it gives convenient and efficient compositions of differential privacy for a number of noise distributions, including Gaussian, discrete Gaussian, and binomial distributions. To realize the benefit, this definition can be used coupled with the following two theoretical results.

Suppose that a process runs two operations which are (ρ₁, θ₁)-ACDP and (ρ₂, θ₂)-ACDP respectively. Then, the process is (ρ₁+ρ₂, θ₁+θ₂)-ACDP. Furthermore, a conversion can be made from ACDP to (ϵ, δ)-DP. If a mechanism is (ρ, θ)-ACDP, then it is (ϵ, δ)-DP for:

$$δ = ( {e}^{ϵ} + 1 ) \cdot θ + {inf}_{α} \frac{{e}^{( α - 1 ) ( αρ - ϵ )}}{α - 1} \times {( 1 - 1 / α )}^{α} .$$

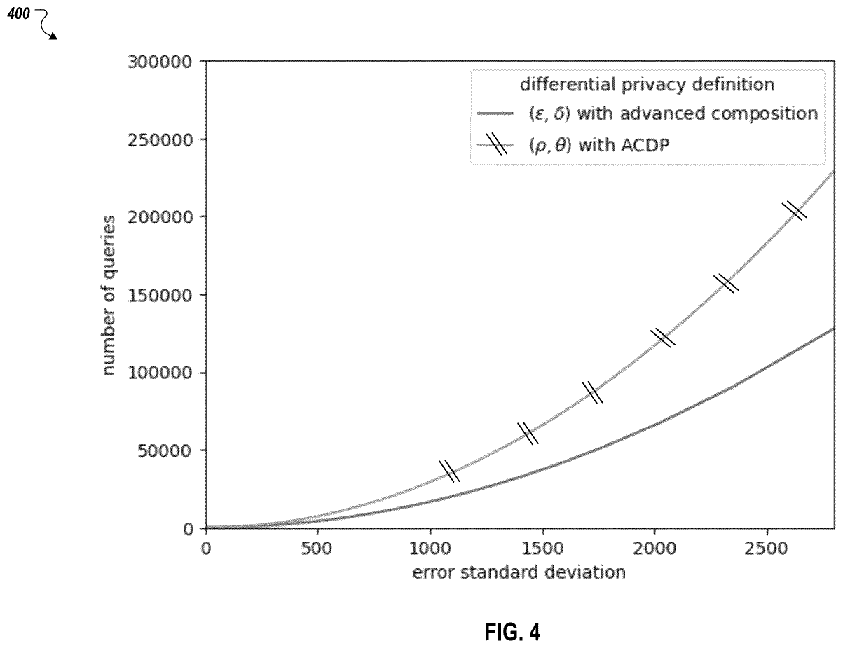

Compared to (ϵ, δ)-DP, the (ρ, θ)-ACDP has multiple advantages. One example advantage is that (ρ, θ)-ACDP achieves a better privacy-accuracy trade-off. For example, and referring now to FIG. 4, FIG. 4 is a graph 400 that illustrates the error standard deviations of differential privacy definitions. In particular, this graph 400 shows the error standard deviations for (ϵ, δ)-DP and (ρ, θ)-ACDP definitions for different numbers of queries. As the curve for (ρ, θ)-ACDP if about twice as high as the curve for (ϵ, δ)-DP, this shows that, compared to (ϵ, δ)-DP, (ρ, θ)-ACDP saves privacy in the sense that it affords twice the number of queries, while fixing accuracy (e.g., the error standard definition).

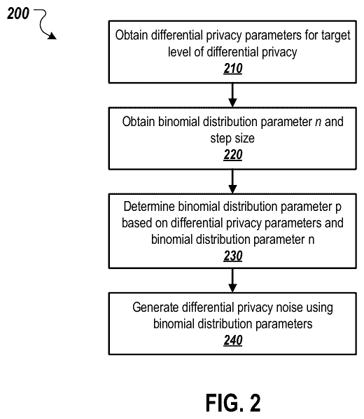

(ρ, θ)-ACDP is also more flexible in the sense that it allows each query to consume different amounts of privacy budget. On the other hand, (ϵ, δ)-DP requires each query to consume exactly the same privacy budget (otherwise the advanced composition fails to work, and the privacy budget accounting is even less efficient). An example technique for generating binomial distribution parameters n and p for ACDP is illustrated in FIG. 2 and described below.

Referring back to FIG. 1, the noise generator 124 can use the binomial distribution parameters n and p to generate noise that is then added to the network measurement data. For example, the noise generator 124 can sample a binomial distribution based on the binomial distribution parameters n and p to obtain a value, e.g., an integer, and provide that value to the query handler 126. The value is the differential privacy noise. The query handler 126 can calculate a network measurement based on a received query using the network data stored in the network data storage device 122. The query handler 126 can add the value received from the noise generator 124 to the network measurement and send, as network measurement data, the noised network measurement to the recipient, e.g., to the digital component distribution system 150 that sent the query.

FIG. 2 is a flow diagram of an example process 200 for generating differential privacy noise. Operations of the process 200 can be performed, for example, by the network measurement system 120 of FIG. 1. The operations of the process 200 can also be implemented as instructions stored on a computer readable medium, which can be non-transitory. Execution of the instructions, by one or more data processing apparatus, causes the one or more data processing apparatus to perform operations of the process 200. For brevity, some operations of the process 200 are described as being performed by a system. The system can be the network management system 120, or another appropriate system.

The system obtains target differential privacy parameters for a target level of differential privacy (210). For example, the target level of differential privacy can vary based on the use case and/or the data that is being provided to recipients. In some implementations, the target level of differential privacy can be set once and, in other implementations, the target level of differential privacy can be adjusted, e.g., by a system administrator or other user.

The target differential privacy parameters can include ACDP differential privacy parameters ρ and θ. The ACDP parameter ρ is the privacy parameter that can be controlled to control the level of privacy and represents a maximum distance between a query on a first database and the same query on a second database with one entry added or removed compared to the first database. That is, the ACDP parameter ρ is a metric of privacy loss. The ACDP parameter θ represents the probability of privacy leakage. The ACDP parameters ρ and θ can be translated between differential privacy parameters ϵ and δ, respectively, as described above with reference to FIG. 1.

In some implementations, the target level of differential privacy varies based on the data being requested. In such implementations, the system can obtain the ACDP parameters based on the data specified by a received query.

The system obtains a distribution parameter n and a step size λ (220). As described above, the distribution parameter n is a number of experiments parameter. The step size λ can be a predetermined step size that is used to adjust the size of the other distribution parameter ρ until a final value for p is found in operation (230) described below. The step size λ can be set based on a desired level of accuracy of the noised data output by the system and/or a target level of computations performed to generate the differential privacy noise. A larger step size λ can result in fewer iterations with lower accuracy while a smaller step size λ can result in more computations but higher accuracy. This accuracy/computation tradeoff is based on the number of iterations of a binary search that is performed using the step size A. The step size λ can typically be a value between zero and one, e.g., 0.1, 0.2, 0.5, 0.7, etc., but may also be larger than one.

The value of distribution parameter n can be preset or predetermined using another process. In some implementations, the system determines the value of distribution parameter n by evaluating multiple values of the distribution parameter n and selecting the value that results in the smallest expected error. For example, the system can evaluate multiple values of the distribution parameter n that are powers of two (or another appropriate value) and select the value that results in the smallest expected error. In general, setting the value of distribution parameter n too small will make it impossible to get (ρ, θ)-ACDP or (ϵ, δ)-DP regardless of the value of the binomial distribution parameter p that is selected. So, one condition may be to select a value of distribution parameter n that is sufficiently large. However, for different (sufficiently large) values of distribution parameter n, there may not be a clear theory to identify the value of distribution parameter n that will result in the smallest amount of noise.

The system determines the binomial distribution parameter p based on the ACDP parameters and the distribution parameter n (230). In general, the system can use a binary search process to find a low value of distribution parameter p for which the differential privacy parameter ρ of the target level of differential privacy is satisfied. To do this, the system can perform a process to determine the value of the ACDP parameter ρ for multiple values of distribution parameter p until a suitable value of distribution parameter p is found for which the ACDP parameter ρ satisfies the target level of differential privacy, e.g., satisfies (ρ, θ)-ACDP. In general, the lower the value of distribution parameter p for which ACDP parameter ρ is satisfied results in greater accuracy (e.g., lower differential privacy noise added to the data).

The system can use two procedures to determine the value of distribution parameter p. A first procedure can adjust the value of distribution parameter p for multiple iterations of a second procedure that evaluates whether the corresponding value of ACDP parameter ρ satisfies the target level of differential privacy. The system can then select the lowest value of distribution parameter p of the iterations for which the corresponding value of ACDP parameter ρ satisfies the target level of differential privacy for use in generating the differential privacy noise. Note that there can be multiple values of distribution parameter p satisfying the target level of differential privacy. Binom(n, p) satisfies the (ρ, θ)-ACDP if and only if Binom(n, 1−p) satisfies the (ρ, θ)-ACDP. For convenience, the system can be configured to always output the value of the distribution parameter p that is smallest or the value equal to 0.5.

In the first procedure, the system can step through different values of distribution parameter p and, for each value of distribution parameter p, and call the second procedure with the values of distribution parameters p and n, the value of ACDP parameter θ, and the step size λ. The output of the second procedure is the value of ACDP parameter ρ based on these inputs.

In the second procedure, the (1−θ) confidence interval of Binom(n, p) is identified. That is, the system identifies the minimum integer a such that F(a)≥θ/2 and identifies the maximum integer b such that 1−F(b−1)≥θ/2, where F(⋅) is the cumulative distribution function (cdf) of Binom(n, p).

The system can compute the log of the normalization factor for the binomial distribution truncated to [a, b] using the following equation:

$$Let Δ = log [ F ( b ) - F ( a - 1 ) ]$$

The system can also compute the log of the normalization factor for the binomial distribution truncated to [a+y, b+y] using the following equation:

$$Let {Δ}_{y} = log [ F ( b + y ) - F ( a + y - 1 ) ]$$

The system can compute the Renyi divergence of order ∞ between the two binomial distributions using the following equation:

$$Let r = {max}_{a \leq x \leq b} \{ log [ f ( x ) ] - log [ f ( x + y ) ] - Δ + {Δ}_{y} \} ,$$

where f is the probability mass function (pmf) of Binom(n, p).

The system sets the initial value of Renyi divergence order α using the following equation:

$$Let α = 1 + λ$$

The system can then evaluate the following while loop until α·ρ≥r. The system can stop at this point because, at this point, the computed divergence d below will always be at most r and thus ρ will not be updated again.

While r>α·ρ:

$$Let d = \frac{1}{α - 1} \cdot log ( {\sum }_{x = a}^{b} exp ( \frac{α \cdot ( log [ ( f ( x ) ] - Δ ) - ( α - 1 ) \cdot ( log [ f ( x + y ) ] - {Δ}_{y} )}{α - 1} ) ) \\ Let ρ = max \{ ρ , \frac{d}{( α - λ )} \} \\ Let α = α + λ$$

During this while loop, the system computes the Renyi divergence d of order α between the two truncated binomial distributions. For each computation of this Renyi divergence, the system updates the current value of ρ and α until the while loop condition of r>α·ρ is satisfied. Finally, after running this second procedure for y=−1 and y=1, the second procedure outputs the ACDP parameter ρ for the inputs to the second procedure.

The system can then determine whether the computed ACDP parameter ρ satisfies the target value of ACDP parameter ρ. For example, the system can determine whether the computer ACDP parameter ρ is less than or equal to the target value of ACDP parameter ρ. If the computed ACDP parameter ρ does not satisfy the target value of ACDP parameter ρ, the system can return to the first procedure to step to the next value of distribution parameter p and call the second procedure with the other input values and the updated value of distribution parameter p.

As there can be multiple values of distribution parameter p satisfying the target level of differential privacy, the system can also return to the first procedure if the computed ACDP parameter ρ does satisfy the target value of ACDP parameter ρ. In this way, the system can find a most suitable value of distribution parameter p that results in a lower amount of noise that still satisfies (ρ, θ)-ACDP. For example, the system can select a value of the distribution parameter p from multiple values of the distribution parameter p for which the computed ACDP parameter ρ satisfies the target value of ACDP parameter ρ. As described above, the system can be configured to output the value of the distribution parameter p that is smallest or the value equal to 0.5.

The system generates differential privacy noise using the binomial distribution parameters p and n (240). In some implementations, the system can generate a binomial distribution of values, e.g., integers, using the binomial distribution parameters p and n and select, as the differential privacy noise, a value at random from the binomial distribution.

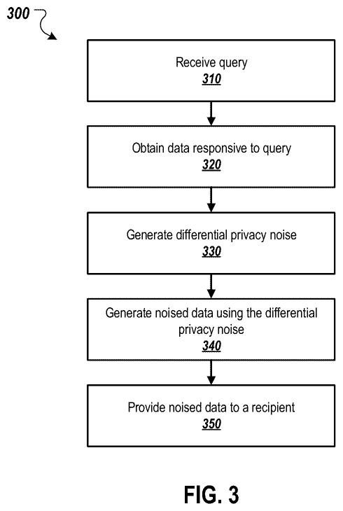

FIG. 3 is a flow diagram of an example process 300 for applying differential privacy noise to data of a dataset and providing the noised data to a recipient. For example, the process 300 can be used to apply the differential privacy noise generated using the process 200 to data elements of a dataset. Operations of the process 300 can be performed, for example, by the network measurement system 120 of FIG. 1. The operations of the process 300 can also be implemented as instructions stored on a computer readable medium, which can be non-transitory. Execution of the instructions, by one or more data processing apparatus, causes the one or more data processing apparatus to perform operations of the process 300. For brevity, some operations of the process 300 are described as being performed by a system. The system can be the network management system 120, or another appropriate system.

The system receives a query (310). The query can be received from a data consumer for which the system stores data. For example, the data consumer can be a digital component distribution system.

The query can specify data for retrieval in response to the query. For example, the query can include criteria, such as a type of data, a type of network measurement, a digital component identifier for a digital component for which data should be retrieved, and/or a digital component group identifier for a group of digital components for which data should be retrieved.

The system obtains data responsive to the query (320). The system can query a dataset using the criteria specified by the query to obtain and/or generate data that satisfies the criteria. If the query is for network measurement data, the system can obtain the appropriate data from the dataset and compute the network measurement using the obtained data. For example, if the query is for a number of unique viewers that viewed a digital component over a given time period, the system can identify, in a dataset, the event data that indicates presentations of the digital component using the digital component identifier for the digital component and count the number of times the digital component was presented to users during the time period. If the query is for a number of unique viewers of the digital component, the system can identify this same event data and count the number of unique users to which the digital component was presented.

The system generates differential privacy noise (330). For example, the system can generate differential privacy noise using the process 200 of FIG. 2. In such an example, the differential privacy noise can be an integer.

The system applies the differential privacy noise is applied to the obtained data (340). The system can apply the differential privacy noise to the data by adding the differential privacy noise to the obtained data. For example, if the data is a number of presentations and the differential privacy noise is an integer, the system can compute the sum of the number of presentations and the integer.

The system provides the noised data to a recipient (350). For example, the system can provide the noised data to the data consumer that sent the query as a response to the query.

In this example, the differential privacy noise is generated and applied at query time. In other examples, the system can generate differential privacy noise and/or apply the differential noise to data of a dataset and store the noise and/or noised data in a data storage device. In this way, the noise can be applied and/or the noised data can be sent in response to queries in a faster way. However, if the data is subject to frequent changes, applying noise to the data in response to a query may result in more accurate data.

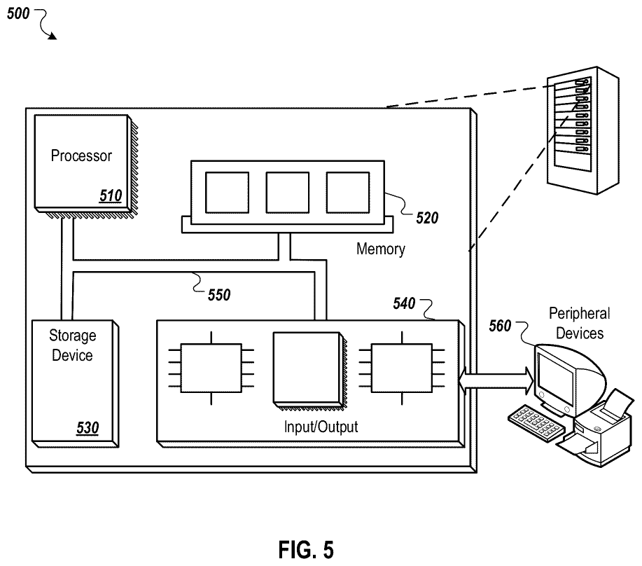

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining a first binomial distribution parameter;
obtaining target differential privacy parameters representing a target level of differential privacy, the target differential privacy parameters comprising a first target differential privacy parameter representing a privacy metric that controls a level of privacy of data;
for each value of multiple values of a second binomial distribution parameter,
determining, based on the value of the second binomial distribution parameter, an actual value of a first actual differential privacy parameter that represents an actual privacy metric, and
determining whether the actual value of the first differential privacy parameter satisfies the first target differential privacy parameter;
selecting, from a set of values of the second binomial distribution parameters for which the actual value of the first actual differential privacy parameter satisfies the first target differential privacy parameter, a given value of the second binomial distribution parameter;
generating differential privacy noise using the first binomial distribution parameter and the given value of the second binomial distribution parameter; and
applying the differential privacy noise to data to generate noised data.

2. The computer-implemented method of claim 1, further comprising sending the noised data to one or more recipients after applying the differential privacy noise to the data.

3. The computer-implemented method of claim 1, wherein the data comprises data for digital components.

4. The computer-implemented method of claim 3, wherein the data for the digital components comprises network data measurement data for the digital components.

5. The computer-implemented method of claim 1, wherein the first binomial distribution parameter comprises a number (n) of experiments parameter and the second binomial distribution parameter comprises a probability (p) parameter.

6. The computer-implemented method of claim 1, wherein obtaining the distribution parameters comprises obtaining the distribution parameters based on an almost concentrated differential privacy (ACDP) approach.

7. The computer-implemented method of claim 1, wherein determining whether the actual value of the first differential privacy parameter satisfies the first target differential privacy parameter comprises determining multiple values of a Renyi divergence order until a stop condition is reached.

8. The computer-implemented method of claim 1, wherein determining an actual value of a first actual differential privacy parameter comprises performing a binary search for the first actual differential privacy parameter.

9. The computer-implemented method of claim 1, wherein for each of multiple values of the second binomial distribution parameter, determining, based on the value of the second binomial distribution parameter, the actual value of the first actual differential privacy parameter comprises:
performing a first procedure to iterate through the multiple values of the second binomial distribution parameter; and
for each iteration of the first procedure, calling a second procedure to determine the actual value of the first actual differential privacy parameter, wherein calling the second procedure comprises providing, as input to the second procedure, the value of the second binomial distribution parameter, a value of the first binomial distribution parameter, and a value of a second target differential privacy parameter that represents a probability of a privacy leakage.

10. The computer-implemented method of claim 9, wherein the second procedure comprises determining a Renyi divergence between two truncated binomial distributions and updating the value of the first actual differential privacy parameter based on the Renyi divergence.

11. A system comprising:
one or more computers; and
one or more storage devices storing instructions that when executed by the one or more computers, cause the one or more computers to perform operations comprising:
obtaining a first binomial distribution parameter;
obtaining target differential privacy parameters representing a target level of differential privacy, the target differential privacy parameters comprising a first target differential privacy parameter representing a privacy metric that controls a level of privacy of data;
for each value of multiple values of a second binomial distribution parameter,
determining, based on the value of the second binomial distribution parameter, an actual value of a first actual differential privacy parameter that represents an actual privacy metric, and
determining whether the actual value of the first differential privacy parameter satisfies the first target differential privacy parameter;
selecting, from a set of values of the second binomial distribution parameters for which the actual value of the first actual differential privacy parameter satisfies the first target differential privacy parameter, a given value of the second binomial distribution parameter;
generating differential privacy noise using the first binomial distribution parameter and the given value of the second binomial distribution parameter; and
applying the differential privacy noise to data to generate noised data.

12. The system of claim 11, wherein the operations comprise sending the noised data to one or more recipients after applying the differential privacy noise to the data.

13. The system of claim 11, wherein the data comprises data for digital components.

14. The system of claim 13, wherein the data for the digital components comprises network data measurement data for the digital components.

15. The system of claim 11, wherein the first binomial distribution parameter comprises a number (n) of experiments parameter and the second binomial distribution parameter comprises a probability (p) parameter.

16. The system of claim 11, wherein obtaining the distribution parameters comprises obtaining the distribution parameters based on an almost concentrated differential privacy (ACDP) approach.

17. The system of claim 11, wherein determining whether the actual value of the first differential privacy parameter satisfies the first target differential privacy parameter comprises determining multiple values of a Renyi divergence order until a stop condition is reached.

18. The system of claim 11, wherein determining an actual value of a first actual differential privacy parameter comprises performing a binary search for the first actual differential privacy parameter.

19. The computer-implemented method of claim 11, wherein for each of multiple values of the second binomial distribution parameter, determining, based on the value of the second binomial distribution parameter, the actual value of the first actual differential privacy parameter comprises:
performing a first procedure to iterate through the multiple values of the second binomial distribution parameter; and
for each iteration of the first procedure, calling a second procedure to determine the actual value of the first actual differential privacy parameter, wherein calling the second procedure comprises providing, as input to the second procedure, the value of the second binomial distribution parameter, a value of the first binomial distribution parameter, and a value of a second target differential privacy parameter that represents a probability of a privacy leakage.

20. One or more computer-readable storage media storing instructions that, when executed by one or more computers, cause the one or more computers to perform operations comprising:
obtaining a first binomial distribution parameter;
obtaining target differential privacy parameters representing a target level of differential privacy, the target differential privacy parameters comprising a first target differential privacy parameter representing a privacy metric that controls a level of privacy of data;
for each value of multiple values of a second binomial distribution parameter,
determining, based on the value of the second binomial distribution parameter, an actual value of a first actual differential privacy parameter that represents an actual privacy metric, and
determining whether the actual value of the first differential privacy parameter satisfies the first target differential privacy parameter;
selecting, from a set of values of the second binomial distribution parameters for which the actual value of the first actual differential privacy parameter satisfies the first target differential privacy parameter, a given value of the second binomial distribution parameter;
generating differential privacy noise using the first binomial distribution parameter and the given value of the second binomial distribution parameter; and
applying the differential privacy noise to data to generate noised data.
